(19) United States
(12) Patent Application Publication
(10) Pub. No.: US 2026/0101588 A1
(43) Pub. Date: Apr. 9, 2026

(54) MANUFACTURING PROCESS FOR A 3D ASSEMBLY

(71) Applicant: Commissariat à I'Énergie Atomique et aux Ènergies Alternatives, Paris (FR)

(72) Inventor: Aurélie Beaumont, Grenoble (FR)

(73) Assignee: Commissariat à I'Énergie Atomique et aux Ènergies Alternatives, Paris (FR)

(21) Appl. No.: 19/320,192

(22) Filed: Sep. 5, 2025

(30) Foreign Application Priority Data
Sep. 6, 2024 (FR) FR2409504

(51) Int. Cl. H10D 88/00; G06F 30/20; G06F 111/20; G06F 113/18; H10B 80/00; H10D 89/10; H10P 72/70; H10W 20/20; H10W 70/652; H10W 90/00; H10W 90/20; H10W 90/26

(52) U.S. Cl. CPC H10D 88/01; G06F 30/20; H10B 80/00; H10D 89/10; H10P 72/7426; H10P 72/7434; H10P 72/744; H10W 20/213; H10W 70/6528; H10W 90/26; H10W 90/297; H10W 90/792; G06F 2111/20; G06F 2113/18

(57) ABSTRACT

The present description concerns a process including the following steps: providing a plurality of assemblies, each including a donor substrate covered by a functional block successively including a first interconnection layer, a functional layer, and a second interconnection layer, the functional layer including one or more electronic components, the interconnection layers including a dielectric material in which are formed conductive elements, a first surface of the first interconnection layer in contact with the donor substrate and the free surface of the second interconnection layer being planarized so as to be compatible with a subsequent direct bonding, successively transferring, onto a receiver substrate the functional blocks, by direct bonding, to form a 3D assembly comprising a receiver substrate covered by a stack of two functional blocks.

### CROSS REFERENCE TO RELATED APPLICATION

This application claims priority to French application number FR2409504, filed Sep. 6, 2024. The contents of this application is incorporated herein by reference in its entirety.

### TECHNICAL FIELD

The present disclosure generally concerns the field of microelectronics, and more particularly, 3D assembly processes as well as the resulting 3D assemblies.

### PRIOR ART

Microelectronics designates all the technologies used to manufacture components which use electrical currents to transmit, process, or store information. Microelectronic technologies are largely responsible for the tremendous advances made in recent decades in the field, among others, of computing, telecommunications, and imaging.

Microelectronics technologies have, in particular, enabled in the last years to introduce on the market new products (smartphone, electric car, etc.) offering users new systems (connected screens, integrated circuits, etc.) incorporating new components (micro-LEDs, transistors, etc.), with, every year, improvements in terms of functionality (for example: memory size, number of processor cores, miniaturization, etc.).

This ‘functional’ evolution of the sector of microelectronics is currently having a negative impact on the environment. In particular, one can mention the use of natural resources: rare metals, water consumption, increased energy consumption through the adoption of new devices, waste production, etc.

To decrease the environmental impact of microelectronics, companies can individually rely on the ISO14004 and ISO14006 standards, which provide guidelines to help organizations establish, document, implement, maintain, and continuously improve their eco-design management and its implementation.

Significant research and development (R&D) efforts are currently under way worldwide to expand the range of technologies available for component assembly. This research is mainly focused on 3D (or 2.5D or 3.5D) assembly, which consists in stacking substrates or dies vertically, with die thinning techniques, with the aim of achieving increased integration. These 3D techniques enable to increase the performance (for example, the bandwidth between a processor and a memory), to decrease power consumption by replacing a long horizontal connection with a short vertical connection, and to lower production costs by selecting the technology best suited to the desired function. It is thus a major tool in an eco-design approach for microelectronics, but which faces both technological and organizational issues.

3D assembly is based on various fine pitch vertical interconnect technologies: direct bonding of structured metal-dielectric surfaces (hybrid bonding), high-density through-silicon vias (TSV) or through-dielectric vias (TDV), Damascene level (“ReRouting”) or redistribution layer (“ReDistribution Layer” or RDL).

These 3D assembly technologies are well known and controlled at the substrate (or wafer) scale, that is, at the scale of a 200-mm or 300-mm silicon substrate, for a small number of assemblies (in the order of from 2 to 3 stacks). However, they are very difficult to apply for a large number of assemblies at the substrate scale, and even more so at the die scale.

Indeed, all these 3D assembly technologies are based on damascene-type processes, which comprise at least one step of planarization of the component surfaces by chemical mechanical polishing (CMP). Now, CMP planarization is a process which induces significant edge effects (“CMP at the Wafer Edge—Modeling the Interaction between Wafer Edge Geometry and Polish Performance” (2005) Materials Research Society symposia proceedings. Materials Research Society 867). Each 3D assembly thus causes a degradation of the edges of the wafers or of the dies by a local erosion phenomenon, making it difficult or even impossible to add the next stack. It also is a highly-impacting process for the reliability of devices, as it induces intra-and inter-layer microcracks, a phenomenon that increases with the number of damascene levels (“Impact of the CMP Process on the Multilevel Stack Mechanical Reliability” (2008) 10th Electronics Packaging Technology Conference).

Hybrid bonding also requires a CMP step to activate the surfaces to be bonded, by creating dangling bonds, and to control the relative heights of the metal pads and of the dielectric array (EP 2863420 B1).

Further, new objects of microelectronics are currently manufactured in highly segmented manner. Each microelectronic component company (for example, of fabless or IDM (“Integrated Device Manufacturer”) type) develops and manufactures one or more semiconductor components having a basic function (RF, memory, logic, etc.) according to a design which is specific thereto, with an adapted material, in a manufacturing plant of its choice (foundry, IDM, etc.), according to its own technological and environmental roadmap. The substrates on which these components have been manufactured are generally silicon wafers having a 200-mm or 300-mm diameter. To assemble the components, package them, and test the obtained integrated systems (IC dies for “Integrated Circuit,” or micro-displays, etc.), semiconductor manufacturers mainly use companies specializing in the assembly and the testing of semiconductor components (OSAT for ‘Outsourced semiconductor assembly and test’), except for a few IDM manufacturers which have their own assembly plants. For this assembly, the wafers with their components are cut into dies, and the dies are assembled by micro-welding onto a package substrate, via depositions of contacts made of a copper alloy plated with tin, nickel, or gold, and then molding in plastic.

In this context, the 3D assembly of dies or of substrates is very complex since it raises many incompatibility issues: in terms of substrates (materials of different diameters, nature, for example), of design (different die size, functions not optimized for use, particularly for assembly), manufacturing technologies (different alignment marks depending on the foundries, test methods, materials used for the functions and connections).

### SUMMARY OF THE INVENTION

There exists a need to have an easy-to-implement manufacturing process for 3D assemblies, where the 3D assembly may have a plurality of functional blocks while offering a good mechanical strength, a reduced footprint, and a good performance.

This aim is achieved by a 3D assembly manufacturing process comprising the following steps:
providing at least two assemblies, each comprising a donor substrate covered by a functional block comprising, successively, a first interconnection layer, a functional layer, and a second interconnection layer, the functional layer comprising one or more electronic components, the first interconnection layer and the second interconnection layer comprising a dielectric material in which are formed conductive elements, preferably made of copper, a first surface of the first interconnection layer in contact with the donor substrate and the free surface of the second interconnection layer being planarized so as to be compatible with a subsequent direct bonding,
transferring, successively, onto a receiver substrate, the functional blocks, by direct bonding, the conductive elements of the first interconnection layer of the first functional block being opposite and in contact with the conductive elements of the second interconnection layer of the second functional block, whereby a 3D assembly comprising a receiver substrate covered by a stack of two functional blocks is obtained.

According to a specific embodiment, at least 5 functional blocks, preferably at least 10 functional blocks, are successively transferred to the receiver substrate during step iv).

According to a specific embodiment, after the transfer of the functional blocks, the process comprises the following steps:
bonding the 3D assembly to an adhesive,
cutting the receiver substrate and the functional blocks and removing the receiver substrate,

whereby a plurality of stacks of singulated functional blocks are obtained,
optionally, bonding the different stacks of singulated functional blocks to an external element, such as a printed circuit board or a laminated substrate.

According to a specific embodiment, one of the functional blocks partially covers the donor substrate, interconnection blocks being arranged on the donor substrate on each side of said functional block and, during step iv), said functional block and the interconnection blocks are transferred simultaneously onto the receiver substrate.

According to a specific embodiment, at least one of the assemblies provided at step i) is obtained according to the following steps:
providing a temporary substrate covered by the functional layer,
forming the first interconnection layer on a first surface of the functional layer and planarizing it,
transferring the first interconnection layer and the functional layer onto the donor substrate, by bonding the donor substrate to the functional layer and separating the temporary substrate,
forming the second interconnection layer on a second surface of the functional layer,
planarizing the second interconnection layer.

According to a specific embodiment, part of or all the functional blocks comprise electronic dies.

This aim is also achieved by a method of determining the steps of a 3D assembly manufacturing process, the determination method comprising the following steps:
defining functions of the 3D assembly, the 3D assembly comprising a substrate and a stack of different functional blocks,
simulating the 3D assembly by selecting different natures and/or dimensions of the substrate and/or functional blocks and/or by selecting different stacks of functional blocks, whereby a first manufacturing process for the 3D assembly is selected.

According to a specific embodiment, at least another manufacturing process for the 3D assembly is defined and compared with the first 3D assembly manufacturing process according to several criteria, for example in terms of feasibility, of technical risk, of functionality, of cost and/or of impact on the environment, so as to select the most suitable 3D assembly manufacturing process.

This aim is also achieved by a 3D assembly comprising a receiver substrate on which are stacked at least two functional blocks, preferably at least 5 functional blocks, even more preferably at least 10 functional blocks,

each functional block comprising a functional layer, comprising one or more electronic components, arranged between two interconnection layers, the interconnection layers comprising a dielectric material in which are formed conductive elements, preferably made of copper,

each functional block being planar.

According to a specific embodiment, each functional block comprises an electronic die.

This aim is also achieved by an assembly comprising a donor substrate covered by a functional block successively comprising a first interconnection layer, a functional layer, and a second interconnection layer, the functional layer comprising one or more electronic components, the first interconnection layer and the second interconnection layer comprising a dielectric material in which are formed conductive elements, preferably made of copper, a first surface of the first interconnection layer in contact with the donor substrate and the free surface of the second interconnection layer being planarized so as to be compatible with a subsequent direct bonding.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1A, FIG. 1B, FIG. 1C, FIG. 1D, and FIG. 1E schematically show different steps of a 3D assembly manufacturing process, according to a specific embodiment of the invention;

FIG. 2A, FIG. 2B, and FIG. 2C schematically show, in cross-section and in side view, a 3D assembly according to different specific embodiments of the invention;

FIG. 3A, FIG. 3B, FIG. 3C, FIG. 3D, FIG. 3E, and FIG. 3F schematically show different steps of a manufacturing process for a donor substrate covered by a functional block, according to a specific embodiment of the invention;

FIG. 4A, FIG. 4B, FIG. 4C, FIG. 4D, FIG. 4E, FIG. 4F, FIG. 4G, FIG. 4H, FIG. 4I, FIG. 4J, FIG. 4K, and FIG. 4L schematically show different steps of a manufacturing process for a donor substrate covered by a functional block, according to another specific embodiment of the invention;

FIG. 5A, FIG. 5B, FIG. 5C, FIG. 5D, and FIG. 5E schematically show, in cross-section and in side view, a temporary substrate according to different specific embodiments of the invention;

FIG. 6 schematically shows, in cross-section and in side view, a receiver substrate according to a specific embodiment of the invention;

FIGS. 7A, 7B, and 7C schematically show different steps of a method of cutting a receiver substrate covered by a plurality of functional blocks, according to a specific embodiment of the invention;

FIG. 8 schematically shows, in top view, the receiver substrate of FIG. 7C;

FIG. 9A, FIG. 9B, FIG. 9C, and FIG. 9D schematically show different steps of a method of assembling electronic dies on a final substrate, according to a specific embodiment of the invention;

FIG. 10A, FIG. 10B, and FIG. 10C schematically show a method of 3D assembly of functional blocks from different plates, each covered by a functional block, according to another specific embodiment of the invention;

FIG. 11A, FIG. 11B, FIG. 11C, FIG. 11D, FIG. 11E, FIG. 11F, and FIG. 11G schematically show a method of 3D assembly based on donor substrates covered by functional blocks comprising ‘HBM DRAM’ dies, according to another specific embodiment of the invention;

FIG. 12A, FIG. 12B, FIG. 12C, FIG. 12D, FIG. 12E, and FIG. 12F schematically show a method of manufacturing a 3D assembly comprising a ‘Compute’ functional block, functional blocks comprising ‘HBM DRAM’ dies, and a ‘Logic’ functional block, according to a specific embodiment of the invention;

FIG. 13 schematically shows, in cross-section, a portion of an artificial intelligence processor according to a specific embodiment of the invention;

FIG. 14 shows, schematically and in cross-section, a receiver substrate comprising an ‘ASIC’ block, according to a specific embodiment of the invention;

FIG. 15A, FIG. 15B, and FIG. 15C schematically show a manufacturing process for a ‘DRAM’ functional block, according to another specific embodiment of the invention;

FIG. 16A, FIG. 16B, and FIG. 16C schematically show a manufacturing process for a ‘Photonic’ functional block, according to another specific embodiment of the invention;

FIG. 17A, FIG. 17B, FIG. 17C, and FIG. 17D schematically show a m 3D assembly manufacturing process comprising an ‘ASIC’ functional block, a ‘DRAM’ functional block, and a ‘Photonic’ functional block, according to a specific embodiment of the invention;

FIG. 18 and FIG. 19 schematically show, respectively in top view and in cross-section, a portion of a heterogeneous assembly for radio frequency, according to a specific embodiment of the invention;

FIG. 20A, FIG. 20B, and FIG. 20C schematically show a method of manufacturing a ‘DHBT’ functional block, according to a specific embodiment of the invention;

FIG. 21 schematically shows, in cross-section, a receiver substrate according to a specific embodiment of the invention;

FIG. 22A, FIG. 22B, and FIG. 22C schematically show different steps in a die manufacturing process according to another specific embodiment of the invention;

FIG. 23 shows, schematically and in cross-section, a device comprising the receiver substrate of FIG. 21 onto which the ‘DHBT’ functional block of FIG. 20C and the dies of FIG. 22C have been transferred, according to a specific embodiment of the invention.

The various elements are not necessarily shown to scale in order to make the figures easier to read.

### DESCRIPTION OF EMBODIMENTS

The same elements have been designated by the same references in the various figures. In particular, structural and/or functional elements common to the different embodiments may have the same references and may have identical structural, dimensional and material properties. For example, the different donor substrate have the same reference, even though the latter may be different. Similarly, the first interconnection layers of the different functional blocks have the same reference, even though they may be different. The same applies to the functional layers and for the second interconnection layers of the different functional blocks.

For the sake of clarity, only those steps and elements that are useful for understanding the described embodiments have been shown and are described in detail.

For a better readability of the drawings, the functional blocks may sometimes be represented in the form of a monoblock so as to avoid showing all the layers of the stack forming the functional block.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

By “in the range from X to Y”, there is meant that the limits X and Y are included.

By compatible with a direct bonding, there is meant that the RMS roughness of the surface to be bonded is in the range from 0 to 1.5 nm, and preferably smaller than or equal to 1 nm, and that the topography (height difference between the metal pads and the dielectric material) is in the range from 0 to 30 nm, preferably smaller than 20 nm.

The 3D assembly manufacturing process comprises the following steps:
providing at least two assemblies, each comprising a donor substrate 10 covered by a functional block 100, 200 successively comprising a first interconnection layer 110, a functional layer 130, and a second interconnection layer 120, the functional layer comprising one or more electronic components as well as through vias preferably made of copper, the first interconnection layer and the second interconnection layer 110, 120 comprising a dielectric material 111, 121 in which are formed conductive elements 112, 122, preferably made of copper, a first surface of the first interconnection layer 110 in contact with donor substrate 10 and the free surface of the second interconnection layer 120 being planarized so as to be compatible with a subsequent direct bonding,
successively transferring, onto a receiver substrate 20, functional blocks 100, 200, by direct bonding, the conductive elements 112 of the first interconnection layer 110 of the first functional block 100 being opposite and in contact with the conductive elements 122 of the second interconnection layer 120 of the second functional block 200, whereby a 3D assembly comprising a receiver substrate covered by a stack of two functional blocks 100, 200 is obtained.

The process may enable to stack more than 2 functional blocks, for example more than 5 functional blocks, preferably more than 10 functional blocks, even more preferably more than 20 functional blocks, and even more preferably more than 50, or even more than 100 functional blocks. The conductive elements of one of the interconnection layers of a functional block are arranged opposite and in contact with the conductive elements of one of the functional layers of the adjacent functional block.

This 3D assembly process for microelectronics consists of stacking a plurality of functional blocks, the two main surfaces of which are planar to be compatible with a direct bonding.

The different functional blocks have been planarized (that is, made planar) one by one on their two surfaces before being assembled. Thus, the blocks are not planarized after their assembly on the receiver substrate. This enables to avoid edge effects and local erosion phenomena and to obtain assemblies having a better integration density and a higher performance.

Such a process allows the 3D assembly of all types of components, and thus paves the way for a wide range of alternative stacks (materials, functions, sizes, etc.).

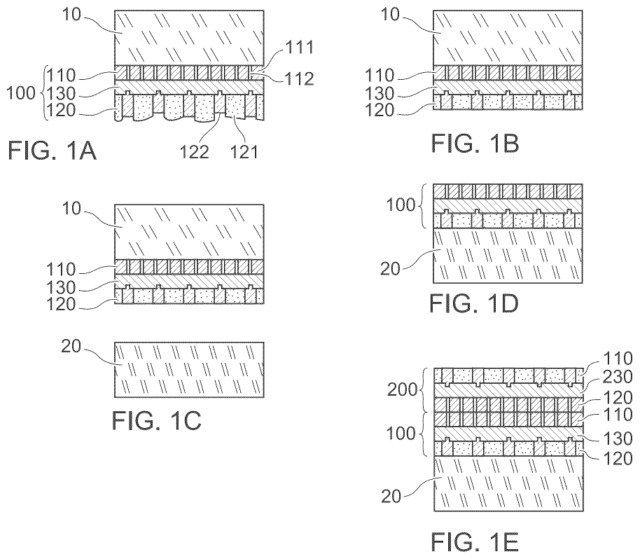

There will now be described in more detail the 3D assembly manufacturing process, referring, first, to FIG. 1A to 1E. The process comprises the following steps:
i) providing an assembly comprising a first donor substrate 10 covered by a first functional block 100 comprising, successively from the first donor substrate 10: a first interconnection layer 110, a functional layer 130, a second interconnection layer 120, the functional layer comprising one or more electronic components as well as through vias preferably made of copper, interconnection layers 110, 120 comprising a dielectric material 111, 121 in which are formed conductive elements 112, 122, preferably made of copper (FIG. 1A), the surface of the first interconnection layer 110 in contact with the donor substrate having been planarized so as to be compatible with a subsequent direct bonding,
ii) carrying out a planarization step on the second interconnection layer 120, so as to make it compatible with a subsequent direct bonding, whereby the first donor substrate 10 is covered by a first planarized functional block 100 (FIG. 1B),
iii) repeating steps a) and b) to form a second donor substrate 10 covered by a second functional block 200 comprising a functional layer 230 arranged between two interconnection layers 110, 120,
iv) transferring onto a receiver substrate 20 by direct bonding and removal of the donor the first functional block 100 and then the second functional block 200, whereby a 3D assembly comprising a receiver substrate 20 covered by two functional blocks 100, 200 is obtained (FIGS. 1D and 1E).

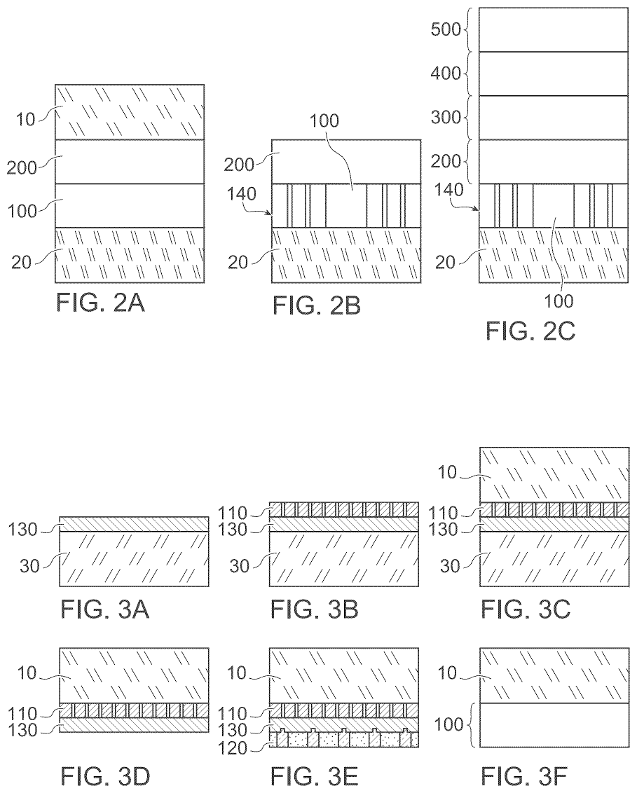

The functional blocks 100, 200 stacked on receiver substrate 20 may be identical (FIG. 2A) or different (FIG. 2B). Step iii) is repeated as many times as necessary to obtain the desired number of functional blocks 100, 200, 300, 400, 500 (for example, 5 functional blocks are shown in FIG. 2C).

According to a first embodiment, for example shown in FIGS. 3A to 3F, the assembly provided at step a) can be obtained according to the following steps:
i.a) providing an initial temporary substrate 30 comprising a functional layer 130 and its associated contacts (FIG. 3A),
i.b) forming the first interconnection layer 110 on the free surface of functional layer 130 and planarizing it (FIG. 3B),
i.c) transferring the first interconnection layer 110 and functional layer 130 onto donor substrate 10:
   by bonding donor substrate 10 to the first interconnection layer 110 (FIG. 3C) and,
   separating all or part of the initial temporary substrate 30 from the assembly formed by donor substrate 10, the first interconnection layer 110, and functional layer 130 (FIG. 3D),
   optionally removing the portion of initial temporary substrate 30 remaining on the assembly formed of donor substrate 10, the first interconnection layer 110, and functional layer 130,
i.d) forming through vias in functional layer 130 as well as a second interconnection layer 120 on a second surface of functional layer 130, and planarizing it, whereby a donor substrate 10 covered by a functional block 100 having its two surfaces ready for the assembly by direct bonding is obtained (FIGS. 3E and 3F).

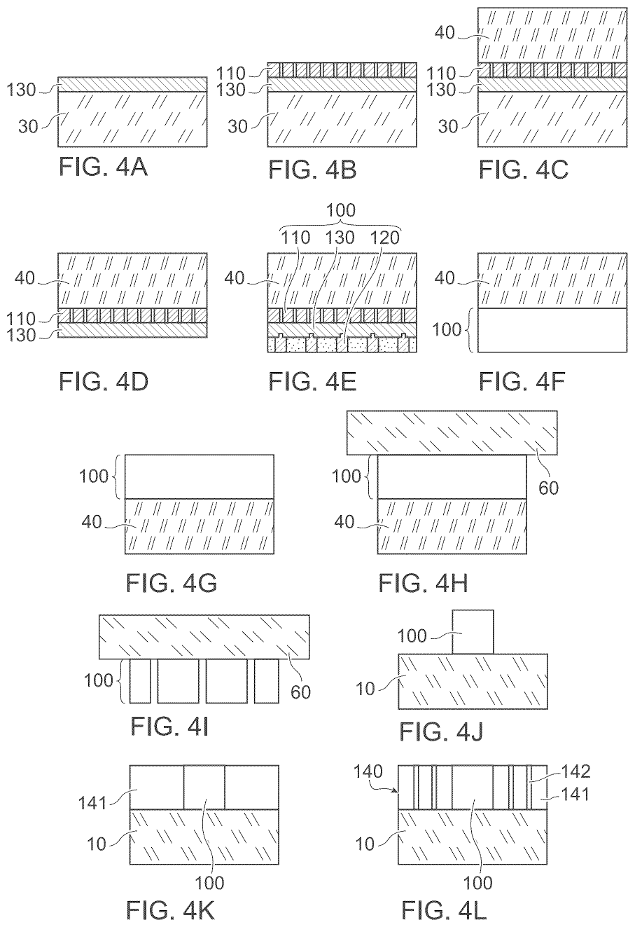

According to another alternative embodiment, for example shown in FIGS. 4A to 4L, the assembly provided at step i) can be obtained by the following steps:
i.a′) providing an initial temporary substrate 30 comprising a first functional layer and its associated contacts 130 (FIG. 4A),
i.b′) forming a first interconnection layer 110 on a first surface of functional layer 130, and planarizing it (FIG. 4B),
i.c′) transferring the first interconnection layer 110 and functional layer 130 onto a second temporary substrate 40:
   by bonding the second temporary substrate 40 to functional layer 130 (FIG. 4C) and,
   by separating all or part of the initial temporary substrate 30 (FIG. 4D),
   optionally by removing the portion of the initial temporary substrate 30 remaining on the assembly formed of temporary substrate 40, interconnection layer 110, and functional layer 130,
i.d′) forming through vias in functional layer 130 and a second interconnection layer 120 on a second surface of functional layer 130, and planarizing it, whereby a temporary substrate 40 covered by a functional block 100 having its two surfaces ready for assembly by direct bonding is obtained (FIGS. 4E, 4F, and 4G),
i.e′) singulating functional block 100 into a plurality of portions (for example, into a plurality of dies in the case where the functional block comprises a plurality of dies), for example by bonding functional block 100 to an adhesive 60 (FIG. 4H), by cutting the second temporary substrate 40 and functional block 100, and then by removing the second temporary substrate 40 (FIG. 4I),
i.f′) transferring one or more portions of functional block 100 onto a donor substrate 10 (FIG. 4J), for example by direct die-to-wafer bonding (D2W),
i.g′) depositing a dielectric material 140 on each side of the bonded portions of functional block 100 (‘Inter Die Gap Fill’) (FIG. 4K), the thickness of dielectric material 140 being greater than the thickness of the functional block portions, and then forming vias and filling them with a metal 142 to form a damascene level, and planarizing the resulting dielectric material/functional block surface (FIG. 4L).

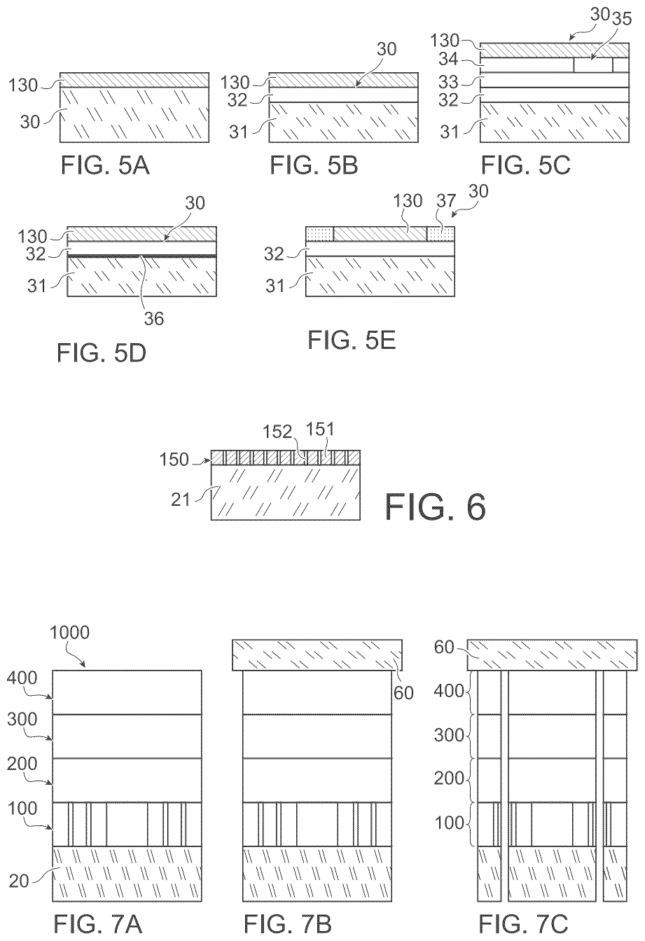

The initial temporary substrates 30 used may be selected from among the following substrates, according to the desired function and assembly:
a solid substrate 30 (silicon, germanium, InP, GaAs, glass, LiTaOs, etc.), for example having a 100-mm, 150-mm, 200-mm, or 300-mm diameter (FIG. 5A),
   a substrate 30 of “X-On-Insulator” type (for example, an SOI, GeOI, InPoSi, POI, GaNOI, substrate etc.) comprising a support substrate 31 covered by a buried oxide layer (BOX) 32 (FIG. 5B), that can be obtained, for example, according to Smart Cut™ technology; the use of an ‘X-On-Insulator’ substrate enables to better control the removal of support substrate 31,
   a substrate 30 of ‘X-On-Insulator-On-Insulator’ type (FIG. 5C) to facilitate the removal of part of initial temporary substrate 30, particularly in the case where this substrate 30 comprises elements (for example, a BOX 32, a semiconductor layer 33, in particular silicon, a cavity 35, for example, a thermal cavity, optical resonators, etc.) located between the upper surface of substrate 30 and an insulating layer 34 covering support substrate 31,
   a substrate 30 of removable substrate type including a buried fragile interface 36, for example located under a BOX or directly under the functional layer for the subsequent removal of support substrate 31 (FIG. 5D); the buried fragile interface 36 may be a controlled bonding interface, a porous layer, a nitrided layer, a release layer such as a Ti (10 nm thick)/Pt (100 nm thick) deposit.

Functional layer 130 may entirely cover initial substrate 30 (FIGS. 5A, 5B, 5C, and 5D) or a portion of initial substrate 30 (FIG. 5E). When functional layer 130 partially covers the temporary substrate, a dielectric material 37 is positioned on the substrate on either side of the functional layer, in coplanar manner, so as to have a planar dielectric surface/functional layer covering temporary substrate 30.

In this case, functional layer 130 may be formed according to processes well known to those skilled in the art. As a non-limiting illustration, it may be formed by local etching (design-related), by manufacturing of a ‘rebuilt wafer’ followed by a planarization of the surface by dielectric deposition and chemical-mechanical polishing. The thickness of a function is typically in the order of from a few hundred nm to a few um or even a few tens of μm. By a few tens of micrometers, there is meant that the thickness is smaller than 100 μm and preferably smaller than 50 μm. Preferably, the thickness of the functional layer is smaller than 1 μm.

The topography of temporary substrates 30 is, preferably, smaller than 200 nm or even smaller than 100 nm, compatible with the subsequent forming of the functional and interconnection layers.

Donor substrate 10 may be selected from among:
a solid substrate, preferably a low-cost silicon substrate or a substrate adapted to the initial substrate in terms of thermo-mechanical behavior (for example, donor substrate having a thermal expansion coefficient close to that of the initial temporary substrate),
a substrate comprising a layer implanted with H⁺ and/or He ions such as described in the Smart Cut™ technology
a substrate comprising a buried fragile layer or interface, for example an SOI substrate comprising a low-adhesion bonding interface,
a substrate comprising a fragile surface layer, for example a porous layer formed by anodization of silicon and/or a separation layer (of Ti 10 nm+Pt 100 nm type, for example),
a substrate comprising alignment marks for the bonding, in order to limit the deformation of the assembly formed by one of the temporary substrates with the donor substrate before the removal of a portion of one of the temporary substrates,
a substrate comprising a strained layer on the back side (for example 60 nm of SiN), in order to limit the deformation of the assembly of one of the temporary substrates with the donor substrate before removal of a portion of one of the temporary substrates.

Donor substrate 10 may be a removable substrate. It may be a silicon substrate having been submitted to a hydrogen implantation step (Smart Cut™ process), a substrate selected so that the bonding energy between donor substrate 10 and the functional block is smaller than the bonding energy between the functional block and receiver substrate 20 (and more particularly the interconnection layer 150 of receiver substrate 20) or than the bonding energy between the functional block and another functional block (according to the position of the functional block in the stack covering receiver substrate 20).

It may also be a composite substrate comprising a support substrate covered by a separation layer (‘release layer’). For example, the release layer is an adhesive layer having adhesive properties that can be decreased by application of ultraviolet radiation or by application of a heat treatment.

According to a variant of the process, donor substrate 10 may comprise one or more metal-dielectric levels forming the BEOL of the function, the first metal level formed on the donor then corresponding to connection layer 110.

During steps 1.c) and 1.c′), the transfer step implements a direct bonding step followed by a separation step. Direct bonding is a bonding technique which requires no addition of material.

Functional layer 130 is bonded to donor substrate 10 or to the second temporary substrate 40 by direct bonding. This type of bonding consists of bringing the surfaces to be bonded into contact with added material, by means of the following preparations: mechanical-chemical polishing of activation of the surfaces and/or chemical cleaning and/or ‘mechanical’ cleaning (Megpie®, ‘scrubber’) and/or plasma activation (He or N₂, for example) and/or activation of SAB (for surface activated bonding) type. These preparations allow the bonding of the metal-dielectric mixed surface to the substrate. The direct bonding may be followed by an anneal for consolidating the bonding in the 100-500° C. range.

When temporary substrate 30, 40 is separated, all or part of substrate 30, 40 may be removed. For example, in the implementation of the Smart Cut™ technology, only a portion of substrate 40 is separated. The implanted portion remains bonded to functional layer 120. The remaining portion may be kept or removed.

The removal of temporary substrate 30, 40 may be performed by mechanical and/or chemical thinning from the surface opposite to functional layer 130. In the case of an SOI substrate, the used temporary silicon substrate 30, 40 may be removed by an etching of the silicon selective over the buried oxide layer: for example, a dry etching using SF6 or a wet etching using TMAH. In the case of a substrate 30, 40 including a buried fragile interface 36, the removal of temporary substrate 30, 40 is performed by fracture at the fragile zone by applying mechanical stress to the bonded structure (insertion of a blade, traction, peeling, etc.).

During step i.e′), the width and length of the portions of the functional blocks are defined by the cutting lines according to the defined 3D stacking.

Preferably, each cut portion corresponds to an electronic die. The thickness of the transferred die may vary between 0.5 μm and 30 μm, preferably between 2 μm and 10 μm according to the targeted application.

At step iv), the bonding is a direct metal-dielectric bonding, the planarization performed for steps 1.c), 1.c′) and 1d) remains compatible, after separation of the donor, with the bonding of two mixed metal-dielectric surfaces. In the case of a wafer-to-wafer bonding, the interconnection pitch at the bonding pads may reach 400 nm or even 50 nm. The thickness of each wafer is, for example, in the range from 300 μm to 1,000 μm. In the case of a die-to-wafer bonding, the interconnection pitch may reach 1 μm or even 200 nm, using die self-assembly techniques. The thickness of the dies is, for example, in the range from 10 μm to 1,000 μm, or even from 2 μm to 1,000 μm. The direct bonding may be followed by an annealing process for consolidating the bonding in the 100-500° C. range. In the case of a heterogeneous assembly implying different materials, the bonding can be assisted by SAB (Surface Activated Bonding) to limit the overall thermal budget of the assembly, SAB allowing very good adhesion of the layers even at room temperature.

It is possible to obtain a dense stack of ultra-thin functions.

During step i.g′), the dielectric may comprise TDV (‘Through-Dielectric-Vias’) vias.

Thus, a donor substrate 10 having a first surface covered by a functional block 100 comprising functional layer 130, arranged between the first interconnection layer 110 and the second interconnection layer 120, is obtained, the surfaces of each interconnection layer being planarized.

Each interconnection layer 110, 120 comprises a dielectric material 111, 121 in which are formed conductive elements 112, 122. Conductive elements 112, 122 form electrically-conductive tracks. The conductive elements are preferably made of copper. Dielectric layer 111, 121 is, for example, made of an oxide or a nitride. In particular, the dielectric layer is made of SiO₂.

Functional layer 130 comprises a functional portion and electrical contacts enabling to connect the functional portion to the interconnection layers. It could also comprise a plurality of functional portions.

Functional layer 130 comprises one or more active electronic components. It may comprise active electronic components (transistors, diodes, etc.) and/or passive electronic components (resistors, capacitors, etc.).

The function of the functional layer is a microelectronics function, for example a calculation function, memory, RF filters, optical amplifiers, etc.

The electrical contacts are selected according to the functional portion. They are developed according to known microelectronics technologies.

The first interconnection layer 110 may comprise one or more damascene layers. For example, the first interconnection layer 110 may be formed of a so-called ‘VIA’ (‘Hybrid Bonding Via’) level connected to the contacts of the functional layer 130, followed by a so-called ‘METAL’ (‘Hybrid Bonding Metal’) level formed above the VIA level. The so-called ‘METAL’ level forms the hybrid bonding surface. It may comprise electrical metal pads (connected to the vias) and so-called ‘dummy’ pads (not connected to the vias) so that the metal density on the surface of the first interconnection layer 110 is in the order of 25%.

The dimensions of the pads are, for example, in the range from 100 nm to 10 μm, advantageously in the range from 500 nm to 5 μm. This density enables to obtain a homogeneous polishing of the mixed metal/dielectric surface to be bonded. Advantageously, the levels that form the first interconnection layer are manufactured in such a way as to limit planarization CMPs, for example by using the well-known double-damascene process. The first interconnection layer may comprise alignment marks for the bonding.

The second interconnection layer 120 may comprise a TSV level alone or a TSV level and one or more damascene levels. The TSV level allows connection to the contacts of functional layer 130 and/or to a higher level (for example, with the first interconnection layer 110). The damascene level(s) forming the second interconnection layer 120 may be constructed in the same way as those of the first interconnection layer 110. In particular, the metal density on the bottom surface of the second interconnection layer 120 is in the order of 25% and the dimensions of the pads are, for example, in the range from 100 nm to 10 μm, advantageously in the range from 500 nm to 5 μm. The second interconnection layer 120 may also comprise alignment marks for the bonding.

The interconnection layers 110, 120 described in this application can be obtained by a damascene-type process and/or a process of ‘via forming’ type (TSV, TDV).

Typically, the damascene process may comprise the following technological steps:
deposition of a layer of dielectric material, for example with a thickness in the range from 50 nm to 50 μm,
forming of through silicon vias in this layer made of a dielectric material by photolithography and etching of the dielectric material,
deposition of a stack comprising sub-layers (bonding sub-layer, diffusion barrier sub-layer, metal seed),
filling of the vias by electrochemical deposition (ECD) of the metal,
chemical-mechanical polishing (CMP) of the metal until a mixed metal-dielectric surface is obtained.

This sequence of steps may be used to form the BEOL (Back-End-Of-Line) of microelectronics components.

During step iii), step i) is repeated to form another functional block 200. Step iii) may be implemented one or more times.

Each functional block 100, 200, 300, 400, 500 may comprise identical or different functional parts, contacts, and/or connections. The selection of functional blocks 100, 200, 300, 400, 500 depends on the defined 3D stack.

During step iv), the formed functional blocks 100, 200, 300, 400, 500 are transferred from the temporary donor substrate to a receiver substrate 20. Functional blocks 100, 200, 300, 400, 500, . . . , are transferred one after the others onto receiver substrate 20. It is possible to use a donor substrate 10 comprising a stack of a plurality of functional blocks. During the transfer step, the stack of functional blocks of the donor substrate is transferred onto receiver substrate 20. At the end of step iv), a 3D assembly comprising a receiver substrate 20 and a stack comprising N functional blocks, where N is an integer greater than or equal to 2 (FIG. 7A), is obtained.

The stack of a plurality of functional blocks may be obtained by first preparing a plurality of stacks of two functional blocks, and then by bonding the stacks of two functional blocks two by two, so as to obtain stacks of four functional blocks, and then by assembling the stacks of four functional blocks to obtain stacks of eight functional blocks, and so on.

Receiver substrate 20 may be covered by an interconnection layer 150 comprising a dielectric material 151 in which are formed conductive elements 152 (FIG. 6). The functional active block is then transferred onto the interconnection layer 150 covering receiver substrate 20. The first interconnection layer 110 of functional block 100 is arranged opposite and in contact with the interconnection layer 150 of receiver substrate 20.

Receiver substrate 20 may be covered by one or more functional blocks before the implementation of step iv). Receiver substrate 20 may be of same nature as donor substrate 10. Receiver substrate 20 may subsequently act as a donor substrate, that is, the stack formed on the receiver substrate may then be transferred onto another receiver substrate.

The transfer of the functional blocks onto receiver substrate 20 may be carried out according to the following steps:
assembling donor substrate 10 with receiver substrate 20 by direct bonding of the functional block 100 of donor substrate 10 onto receiver substrate 20, or, if relevant, onto the interconnection layer 150 of receiver substrate 20, or if receiver substrate 20 is already covered by a functional block, onto the functional block,
separating donor substrate 10 from the assembly thus obtained.

The direct bonding applies to heterogeneous dielectric/metal surfaces (interconnection surfaces) and to homogeneous surfaces (dielectric or surface of the donor substrate).

The removal of donor substrate 10 may be achieved by mechanical and/or chemical thinning from the surface opposite to functional layer 120. In the case of a substrate 10 comprising a layer implanted with H+ and/or He ions, the removal may be achieved by the application of thermal and/or mechanical stress, for example by an anneal in the range from 200° C. to 500° C. followed by the insertion of a blade. In the case of a donor substrate comprising a buried or surface fragile layer, the removal is carried out by fracture at the fragile zone, by the application of mechanical stress to the bonded structure (insertion of a blade, traction, peeling, etc.).

According to an alternative embodiment, it is possible to transfer onto receiver substrate 20, in addition to the previously-described functional blocks, one or more blocks having optical functions (LEDs, imagers, photovoltaic cells, etc.) as described in European patent EP 3 769 339 B1.

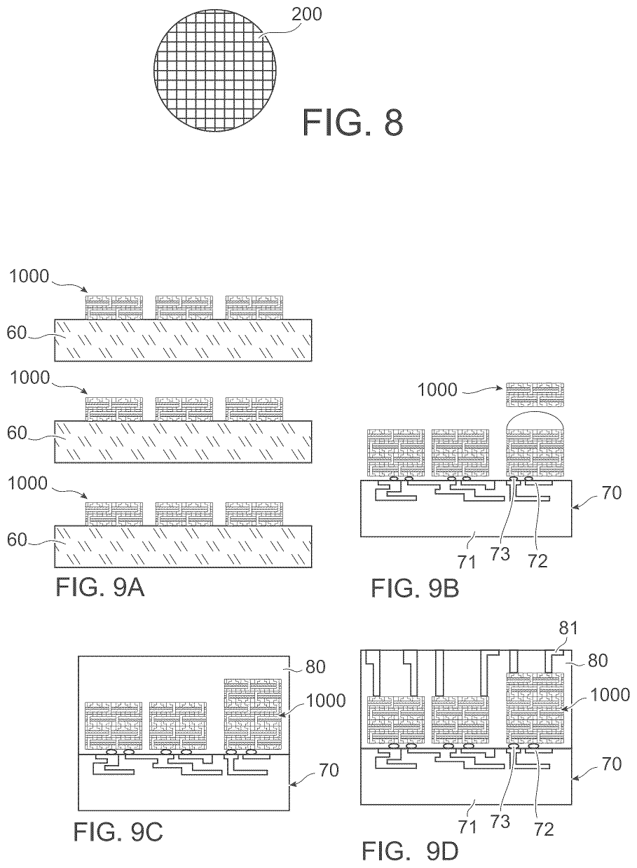

According to an alternative embodiment, as shown in FIGS. 7A to 7C, the process may comprise a subsequent step during which receiver substrate 20 and the stack of active blocks 100, 200, 300, 400 thus obtained (FIG. 7A) are transferred onto a temporary support 60 (FIG. 7B), for example an adhesive support (‘tape’). The assembly is then cut into dies (FIG. 7C). For example, it may be a mechanical cutting, in particular a sawing. FIG. 8 shows a top view of the cut device.

Receiver substrate 20 can then be removed. It is possible to remove all or part of the receiver substrate before the cutting of the dies.

This alternative embodiment is particularly advantageous in cases where dies comprising an assembly of functional layers 120 need to be assembled with other electronic dies. The cutting step leads to the singulation of the dies. The size of the dies (length, width) is defined by the cutting lines according to the defined 3D stack.

The stacks of resulting dies 1000 (FIG. 9A) can then be transferred from adhesive carrier 60 onto a final substrate 70 (FIG. 9B), in particular a package substrate. Substrate 70 may be, for example, a laminated substrate or a printed circuit board. However, the final assembly of the dies on substrate 70 is, for example, achieved by metal-dielectric bonding (direct bonding and/or bonding with added material). Metal/dielectric bonding with added material is an assembly process in which the die stack is assembled on copper pads 72 of substrate 70, by implementing a solder 73, for example made of a CuNiAu alloy or a tin-based alloy, in particular the SnAg alloy. The solder step can be carried out at a temperature in the 100-300° C. range.

It is possible to repeat the steps to obtain a plurality of stacks of different dies, themselves formed of an assembly of functions, which may have different sizes and/or different thicknesses (FIG. 9B).

At the end of the final assembly of dies 1000 to the package substrate, dies 1000 may be protected by being coated with a layer of insulating material 80 (FIG. 9C). Insulating material 80 may be deposited by dispensing or by molding. The insulating material may be a polymer or a resin. The final routing may be obtained, for example, by forming of a non-damascene redistribution layer 81 (RDL) (FIG. 9D).

The previously-described process enables to manufacture a 3D assembly comprising a receiver substrate 20 having at least two functional blocks 100, 200, preferably at least 5 functional blocks, even more preferably at least 10 functional blocks, stacked thereon, each functional block 100, 200 comprising a functional layer 130, comprising one or more electronic components, arranged between two interconnection layers 110, 120, interconnection layers 110, 120 comprising a dielectric material 111, 121 having conductive elements, preferably made of copper, formed therein.

Each functional block 100, 200 is planar. In other words, its main surfaces are planar and parallel to each other.

The assembly may comprise more than 20 functional blocks, or even more than 50 functional blocks stacked one on top of the other.

The pitch of the interconnects is smaller than 10 μm, preferably smaller than 5 μm. It may be in the order of 1 μm. The pitch may be finer. For example, it is smaller than 200 nm, or even smaller than 100 nm. The pitch being fine, the 3D assembly has a high interconnect density, for example, up to 1 million connections per mm² for a 1-μm pitch. It is thus possible to miniaturize electronic devices.

It is thus possible to assemble functions based on different materials without creating thermal stress during assembly by using a suitable donor and a cold hybrid bonding (SAB). The entire assembly is carried out at room temperature, which is particularly advantageous when the functions are made on different materials (for example, InP and silicon, etc.).

The resulting 3D stack, based on the multiple transfer of active layers having structured metal-dielectric connections from removable substrates, for the assembly and the interconnection of electronic components, can be used in many fields.

The previously-described process opens up new possibilities. For example, it enables to create new, original, and high-performance assemblies, particularly by associating a 3D assembly control system with the described technology, known as HSA (‘Hybrid Smart Assembly’ technology).

Based on the functions to be assembled for the targeted application, it is possible to determine a plurality of possible assemblies in advance and to select one according to specific criteria.

The method of determining the steps in a 3D assembly manufacturing process comprises, for example, the following steps:
defining the functions of the desired 3D assembly,
simulating the assembly of the various elements of the 3D assembly, with different types and dimensions of the various functional blocks and/or of the substrates, and/or with different stacking orders of the functional blocks,

whereby a first manufacturing process for the 3D assembly is selected.

At least another manufacturing process for the 3D assembly is obtained and compared with the first potential 3D assembly manufacturing process according to several criteria, for example in terms of feasibility, technical risk, functionality, cost, and/or environmental impact, in order to select the most suitable 3D assembly manufacturing process.

A plurality of potential processes can thus be determined and compared.

The above-described technology allows the assembly of any type of function according to a suitable methodology and manufacturing chain.

The final 3D assembly (object or system) is known and defined in advance. In particular, the desired functions and connections are defined.

The size of the final dies is defined in relation with the functions to be assembled and to the desired aim. For example, for an imager integrating 3 functions (logic, memory, and image capture), the size of the assembled die will be defined by that of the image capture die to optimize the optical efficiency.

HSA technology is described in specific design kits (DKs), for example selected from among: ‘Process Design Kit’, ‘Assembly Design Kit’, ‘Chiplet Design Kit’, and ‘Material Design Kit’.

An eco-design-specific design kit is included, which gathers the life cycle assessment (LCA) data related to interconnect manufacturing (damascene, vias, bonding, removal, etc.). LCAs related to component manufacturing may be added to this DK.

The assembly of functions is simulated with different scenarios:
adaptation of the designs/technology nodes to adjust each function to the final die size,
adaptation of the HSA technology: selection of the substrates, of the connection type, of the stacking order, of the thicknesses, etc.

For example, for an imager, the logic chip may be selected with a relaxed node to have the size of the image capture chip while being inexpensive (rather than an advanced node which generates smaller and more expensive chips). The memory chip may be in an advanced node, smaller than the image capture chip, with connections at the periphery of the memory function.

Each scenario is assessed in terms of feasibility, technical risk, functionality, cost, and environmental impact.

For example, in the case of a GaN-based emissive LED display, a scenario incorporating a photovoltaic layer having an absorption adjusted to the emission wavelength of the LED is compared with a scenario without this PV layer, in order to quantify the environmental and economic impact of this layer: material consumption, cost and impact of the manufacturing of a photovoltaic cell versus the reduction of the energy consumption of the system, . . .

The die manufacturing is then carried out according to the retained scenario.

It is thus possible for different microelectronic component companies (fabless, IDM, etc.) to manufacture one or more functional layers according to a design which is specific thereto, with an adapted material, in a manufacturing plant of their choice according to their own technological and environmental roadmap.

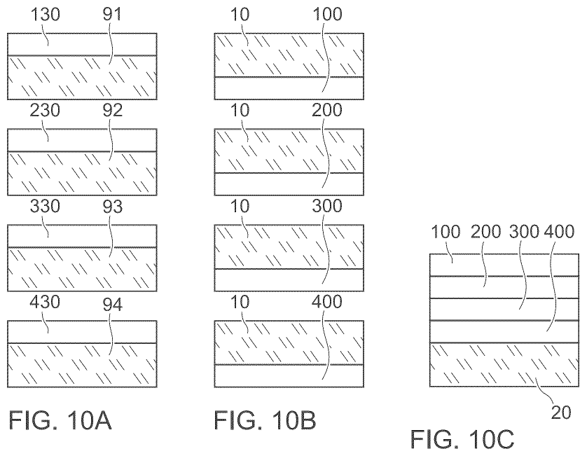

Functional layers 130, 230, 330, 430 are supplied by manufacturers on initial substrates 91, 92, 93, 94 (FIG. 10A). A first interconnection layer is formed on each functional layer 130, 230, 330, 430, after which the first interconnection layer and functional layer 130 are transferred to a donor substrate 10, according to the previously-described steps, for example shown in FIG. 3A to 3F or 4A to 4L. Initial substrates 91, 92, 93, 94 act as the initial temporary substrate 30. After the forming of the second interconnection layer and planarization, functional blocks 100, 200, 300, 400 are formed (FIG. 10B) and may be transferred onto a same receiver substrate 20 (FIG. 10C).

In this context, the 3D assembly of dies or of substrates (“wafers”) is greatly facilitated, since the process enables to do away with incompatibility issues that can arise with different substrates and/or different manufacturing technologies.

In this context, the incompatibility issues which currently limit the adoption of 3D assembly are addressed beforehand, and the assembly of multiple functions using HSA technology can be achieved.

It is thus possible to optimize assemblies from the design stage, while integrating environmental control therein.

The 3D assembly control system enables to optimize the functionality and the costs of assemblies from the design stage. In addition, as part of an eco-design approach, the environmental impact can be taken into account in order to be significantly decreased.

It is thus possible to integrate a 3D assembly control system from the die design stage to the forming of systems or objects. This control of the design and of the manufacturing chain particularly enables, while decreasing manufacturing costs, to decrease impacts on the natural environment, impacts on resource consumption, and impacts on human health.

The various steps can be managed with specific software using artificial intelligence. This is advantageous because there is a very large amount of data to be processed for an effective control of the 3D assembly at all levels: feasibility, functionality, cost, environmental impact, etc.

### Illustrative and Non-Limiting Examples

### 1^{st} Example: High-Bandwidth Memory

In this example, a high-bandwidth memory (HBM) is manufactured. For this purpose, synchronous dynamic random access memory (DRAM) HBM dies are manufactured. These dies are called HBM DRAM dies. Functional blocks known as ‘compute’ and ‘logic’ may be combined with the HBM memory, for example, to form a graphics card.

As an indication, according to the current process, HBM DRAM dies comprising TSVs are connected to each other according to conventional component assembly technologies (for example, by micro-bump or pick-and-place technologies).

The memory, ‘compute’, and ‘logic’ dies are connected by means of an interposer comprising TSVs. This interposer is assembled on the final substrate by copper bumps. The total surface area corresponds to at least that of the HBM die + that of the compute die + that of the logic die. The thickness of the HBM die is limited to 775 μm, which currently corresponds to a maximum of 16 DRAM levels.

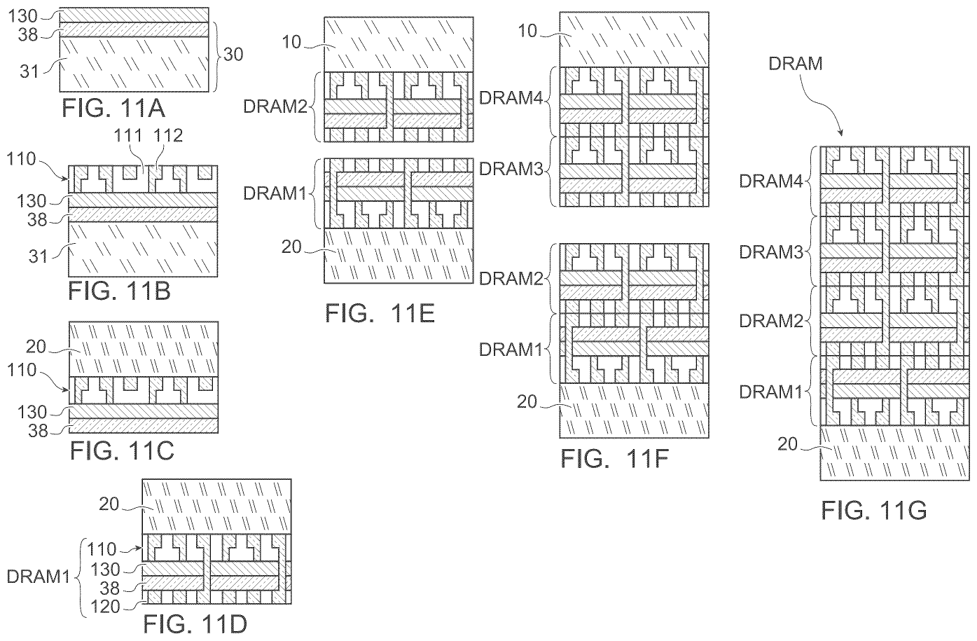

There will now be described in more detail the manufacturing process for the high-bandwidth memory according to a specific embodiment of the invention, first referring to FIGS. 11A to 11G. The process could be applied to a device other than a high-bandwidth memory device.

The DRAM functional layers are manufactured from SOI substrates 30 of 300 mm having a BOX layer 38 according to a 22-nm FDSOI technology. Areas known as NO DUM, that is, areas without silicides, are provided for the subsequent passage of TSVs. The DRAM functional layers are manufactured up to their contact levels. The thickness of a DRAM functional layer is, for example, in the order of from 1 to 3 μm. Silicon support substrate 31 is thus covered with an SiO₂ layer 38 and with the DRAM functional layer 130 comprising one or more DRAM dies (FIG. 11A).

A first interconnection layer 110 is formed on functional layer 130. Interconnection layer 110 comprises a first interconnection level formed on a first surface of the functional layer and a second interconnection level formed on the first interconnection level according to double-damascene copper technology. The interconnection levels are selected so that the first interconnection level connects the DRAM contacts and certain metal pads of the second interconnection level. The second interconnection level comprises alignment marks for the bonding and its Cu density is in the order of 25%. The dimension of the metal pads of the second interconnection level is in the range from 200 nm to 10 μm (FIG. 11B).

DRAM functional layer 130 and the interconnection levels are transferred onto a silicon donor substrate 10 by direct bonding and removal of the SOI substrate (for example, by mechanical polishing and wet etching, for example, with a TMAH solution) (FIG. 11C).

The second interconnection layer 120 is then formed on SiO₂ layer 38. TSVs are formed from SiO₂ layer 38 to the first connection layer 110. These TSVs extend through the SiO₂ layer 38 of the SOI, and the functional layer 130 made of silicon in which the DRAMs are manufactured (the TSVs extend through the NO DUM areas) and the first interconnection level 110. An interconnection level is then formed on the TSV level so that it is connected to certain pads of the first interconnection layer 110. This interconnection level 120 comprises alignment marks for the bonding and its Cu density is in the order of 25%. The dimension of the metal pads is in the order of from 200 nm to 10 μm.

The assembly thus formed corresponds to the first functional block DRAM1 on a silicon donor (FIG. 11D). This assembly then acts as the receiver substrate.

Collectively, 64 assemblies comprising a donor substrate and a DRAM functional block (DRAM1 to DRAM64) are thus manufactured.

Each interconnection layer 110, 120 has been submitted to two CMP planarizations. Each functional block has its two surfaces (upper and lower) ready for bonding.

The assembly of the HBMs is carried out in several steps.

In a first step, the hybrid bonding of functional block DRAM2 to functional block DRAM1, and then the removal of the donor substrate 10 of DRAM2 (FIG. 11E), are performed.

The bonding is performed by a Cu-SiO₂ activation CMP so that the roughness is less than 6 nm RMS and the height difference between the SiO₂ and the Cu is smaller than 15 nm, the Cu level being located below that of the SiO₂. The surfaces are then cleaned with a rinse combined with ultrasound and NaOH-type chemistry. The substrates are brought into contact in industrial hybrid bonding equipment equipped with an alignment module. An anneal at 200° C. is applied to consolidate the structure. The removal of the silicon substrate is performed by mechanical thinning down to a 20-μm thickness, followed by TMAH etching. A stack of two functional blocks, DRAM1 and DRAM2, on a substrate 20 is thus obtained. These steps are repeated to form other stacks of functional blocks.

In a second step, the hybrid bonding of two stacks of two functional blocks (FIG. 11F), followed by the removal of silicon donor substrate 10, is performed. Receiver substrates 20 covered with four functional blocks (for example, DRAM1 to DRAM4 in FIG. 11G) are obtained.

The bonding steps are repeated until obtaining a stack of 64 DRAM functional blocks on silicon substrate 20, that is, 6 block transfers (6 bondings+6 removals). The thickness of the 64 levels forming the HBM memory is in the order of 200 μm. The silicon substrate may typically have a thickness of from 500 μm to 700 μm.

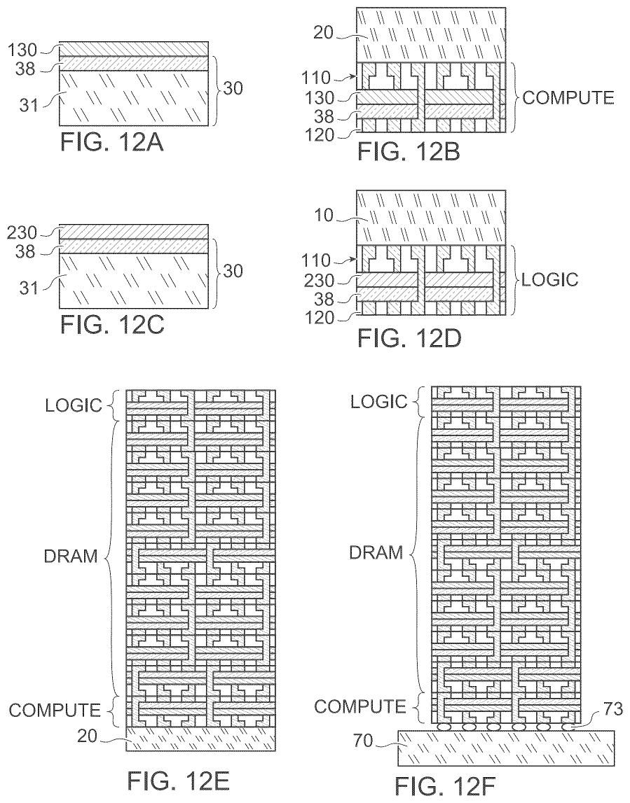

Donor substrates 10 comprising Compute functional blocks and Logic functional blocks are manufactured in the same way as the previously-described DRAM blocks (FIGS. 12A, 12B, 12C, and 12D).

The stack of DRAM functional blocks is transferred onto the COMPUTE functional block and the silicon donor substrate 20 on which the stack of DRAM functional blocks was arranged is removed. The LOGIC functional block is transferred onto the stack of DRAM functional blocks and the silicon substrate on which the LOGIC functional block was arranged is removed (FIG. 12E).

The assembly is cut and assembled with a final substrate 70 by means of solder alloy pads 73 (‘bumps’) (FIG. 12F).

The structure thus formed allows a bringing of the components closer together, an increase in the number of memory layers, an increase in the interconnection density, which are advantageous to improve its performance (particularly the power consumption) and functionality.

It also allows a decrease in the amount of metal used, a decrease in the power consumption, a reduction of the materials forming the structure (and thus a reduction of its heating), which are advantageous to decrease the environmental impact.

### 2^{nd} Example: Processor for Artificial Intelligence

In this example, AI-specific integrated circuits (ASICs) are manufactured by a first foundry on a 300-mm substrate (“wafer”) according to known microelectronics technologies at an advanced node (5 nm or 7 nm) to optimize the component density. According to the design and the manufacturing processes of the foundry, each circuit is typically separated from the others by cutting paths having a width from 10 to 100 μm.

To increase the system performance (dissipation, latency, etc.), it may be then be advantageous to use optical rather than electrical links to so as to improve the connection between circuits on the surface of the final die. It is then necessary to connect the ASIC circuits to photonic circuits. To further increase performance, it may be advantageous to add a memory level to support the calculations of the ASIC circuits. It is then necessary to connect the ASIC circuits to memory circuits.

The stacking and design of the components is simulated by means of the control system to determine the manufacturing technologies for the ASIC, memory, and photonic functions (technology node, etc.), the order in which these functions need to be stacked, and what type of connection (dimension, spacing, etc.) should be used to optimize the performance, cost, and environmental footprint of the processor formed of the 3 functions.

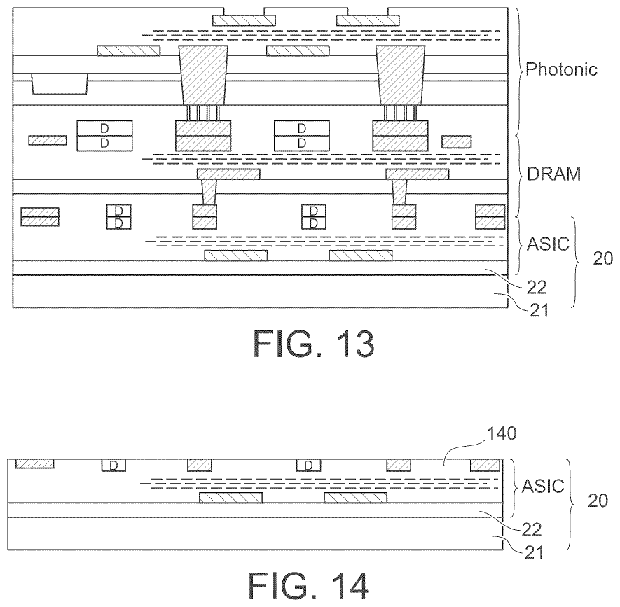

In this example, the optimal system is considered to be that shown in FIG. 13.

Receiver substrate 20 comprises a silicon substrate 21, an ASIC circuit 22, and an interconnection layer 150. ASIC circuit 22 and interconnection layer 150 form the block labeled ‘ASIC’, ASIC circuit 22 is manufactured by a first foundry on a solid silicon substrate 21 (FIG. 14). To be compatible with the invention, the last metal level MZ of ASIC circuit 22 is designed to be connected to a ‘DRAM’ memory functional block by hybrid copper-SiO₂ bonding. It thus comprises alignment marks for the bonding and its Cu density is in the order of 25%. The connection pads are completed by unconnected ‘dummy’ pads (marked D in FIG. 14), which enable to have the most favorable Cu density for the hybrid bonding. The dimension of the metal pads of level MZ is 400 nm.

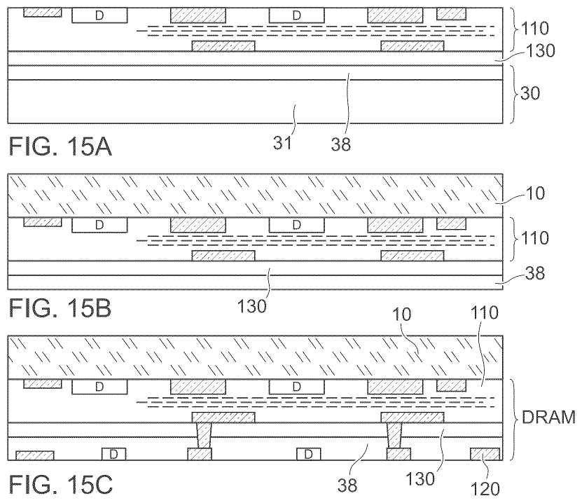

In parallel, a functional layer 130 comprising a DRAM memory circuit is manufactured by a second foundry on an SOI substrate 30 (FIG. 15A), with silicon-free NO DUM areas at the level of the subsequent TSVs. A first interconnect layer 110 (labeled ‘Metal 1’) is formed on the front end of line (FEOL) of the DRAM circuit, after which a plurality of routing levels are manufactured, with a design adapted on the last DRAM1, to be subsequently connected to a photonic functional block (labeled ‘Photonic’) by hybrid Copper-SiO₂ bonding. Again, the last level DRAM1 comprises alignment marks for the bonding, connection pads of 5-μm dimension, and a Cu density of 25% obtained by active connection pads and ‘dummy’ pads (FIG. 15A). In parallel, an Si substrate 10 covered with a 300-nm thick thermal oxide is implanted with H⁺ ions at an 76-keV energy and a 6.10¹⁶/cm² dose (the implantation area is represented by dashes in FIGS. 15B and 15C). The assembly formed by the DRAM circuit and the routing levels is then bonded to the implanted Si substrate 10 by direct bonding, the silicon substrate 31 of the original SOI substrate 30 is removed by mechanical and/or chemical thinning, with a stop on the BOX 38 of the SOI (FIG. 15B). TSVs are formed by etching of the BOX, of the SOI at the NO DUM areas, and of the first level Metal 1 so as to contact level Metal 1. An interconnection layer 120 obtained by creating a damascene routing layer and connections DRAM2 is then formed on the TSVs, the design of which is adapted to being connected to the level MZ of the ASIC functional block (FIG. 15C). The direct bonding, the TSVs, and connection levels DRAM2 are achieved at maximum temperature of 350° C.

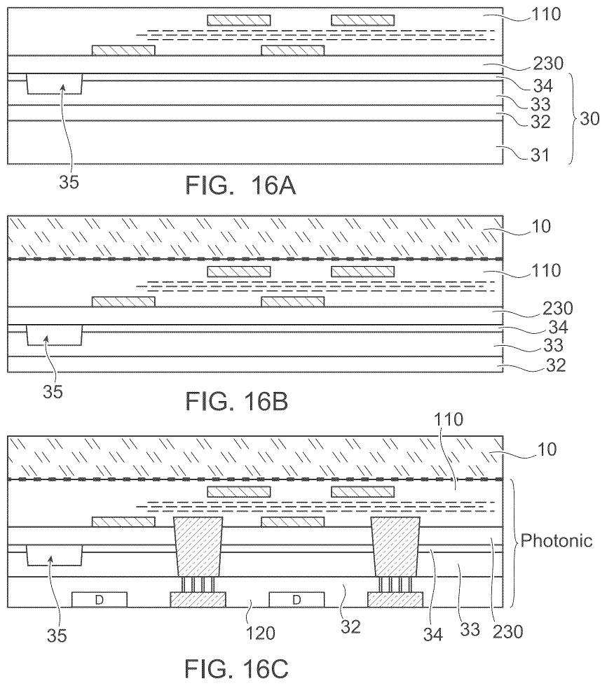

In parallel, a photonic functional layer 230, comprising in particular functions for transforming electrical signal into optical signals, light transport functions, data processing functions, for example by means of laser components, waveguides, data conversion elements (‘serdes’), is manufactured on a double-SOI substrate 30, for example of 300 mm, by a third foundry. Double-SOI substrate 30 comprises: a solid Si substrate 31, a first buried oxide 32 (BOX) of 3-μm thickness, a resistive silicon layer 33 of 30-μm thickness, a second buried oxide 34 of 2-μm thickness, and a crystalline silicon layer of 220-nm thickness (FIG. 16A). The photonic FEOL comprises NO DUM areas at the level of the subsequent TSVs. Interconnection levels 110 are obtained by performing a BEOL damascene on photonic functional layer 130, and then covered with a planarizing oxide layer. The photonic substrate is then bonded by direct bonding to a silicon donor substrate 10 having a slightly rough oxide surface in order to obtain a low bonding energy smaller than 1 J/m². The solid Si substrate 31 is removed by mechanical thinning and selective chemical etching of the silicon, stopping on the BOX of 3-μm thickness (FIG. 16B). TSVs are formed in the 3-μm BOX 32, in the resistive Si 33 of 30-μm thickness, in the second BOX 34 of 2-μm thickness, and in photonic FEOL 230 at the level of the NO DUM areas all the way to level Metal 2 of the BEOL so as to connect it. An interconnection layer 120 is obtained by creating a damascene routing and connection layer on the TSVs, having its design adapted to being connected to the DRAM1 level of the DRAM donor (FIG. 16C).

One thus obtains:
an ASIC 20 substrate ready for assembly,
a DRAM functional block on an implanted donor substrate 10 ready for assembly,
a functional Photonic block on a donor substrate 10 ready for assembly.

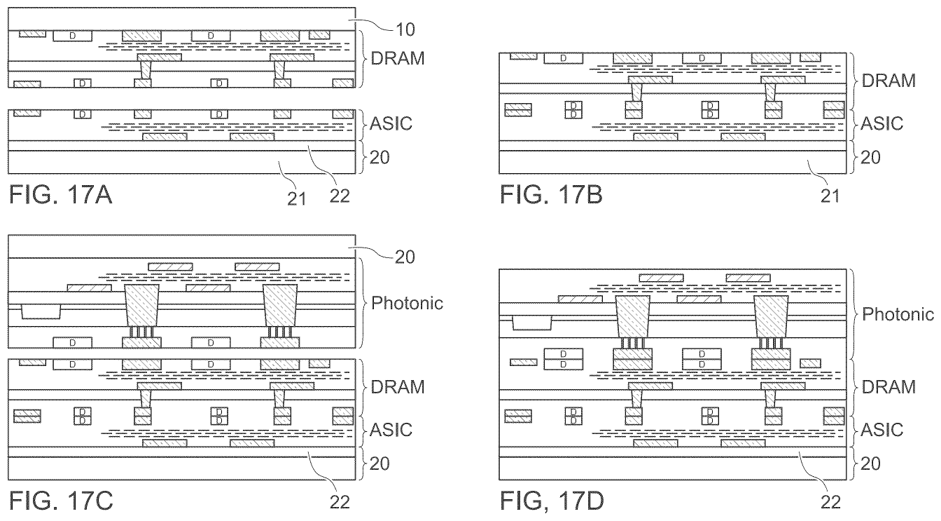

The DRAM block is transferred to the ASIC block by aligned hybrid bonding (FIG. 17A) and application of a heat treatment at 400° C. for 7 hrs. This heat treatment causes a fracture in the hydrogen-implanted area (FIG. 17B). The DRAM block, the 300-nm thick thermal oxide layer, as well as a 400-nm thick silicon layer (corresponding to the implantation depth of hydrogen ions) are thus transferred onto the ASIC block. The 300-nm thick Si layers and 400-nm thick thermal oxide layers are removed by etching and/or chemical-mechanical polishing so that the surface of the DRAM1 level is compatible with a direct bonding. The photonic block is then transferred onto the DRAM block by aligned hybrid bonding (FIG. 17C) and rupture of the fragile bonding interface (FIG. 17D) by the application of mechanical stress (insertion of a blade, etc.).

The desired stack is obtained. A local etching of the oxide above the last metal level of the photonic BEOL allows contact recovery.

### Example 3: Heterogeneous Assembly for RF

In this example, an industrial method is provided for integrating InP-based double heterojunction bipolar transistors (DHBTs) into a silicon digital circuit for ultra-high frequency (THz) RF applications.

A problem of InP-based active circuits is the very high cost of the InP material. Significant efforts are being made to limit the amount of material used by using dies of very small dimensions (up to 0.5×0.5 mm²) transferred onto Si. The active part of InP used (DHBT zone) has a total thickness in the order of one μm. The thickness of InP required to manufacture the RF circuit is in the order of from 500 to 700 μm. An antenna is then applied to the free surface of the InP die, formed for example by a stack of metal/dielectric layers and connected to the InP die. CMOS logic circuits are also required to drive the assembly.

The stacking and the design of the components is simulated by means of the control system to determine the manufacturing technologies for the logic, digital, and RF functions (technology node, materials, etc.), the order in which these functions need to be stacked, and what type of connection (dimension, spacing, etc.) should be used to optimize the performance, cost, and ecological footprint of the processor consisting of the 3 functions. Specific attention is paid to decrease the consumption of InP material, with both environmental and economic objectives in mind.

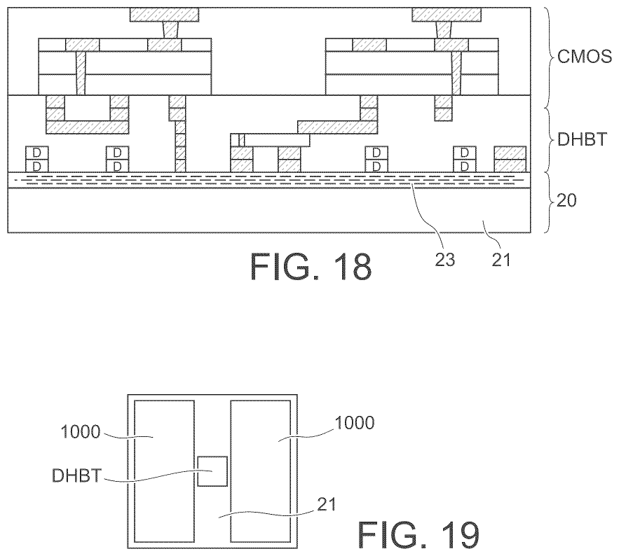

It is here considered that the optimal system is that shown in FIG. 18 and in FIG. 19.

The DHBT function has 1×1-mm² dimensions, the CMOS functions 2×5 mm², and the passive RF functions on high-resistivity Si substrate are 5.5×5.5 mm².

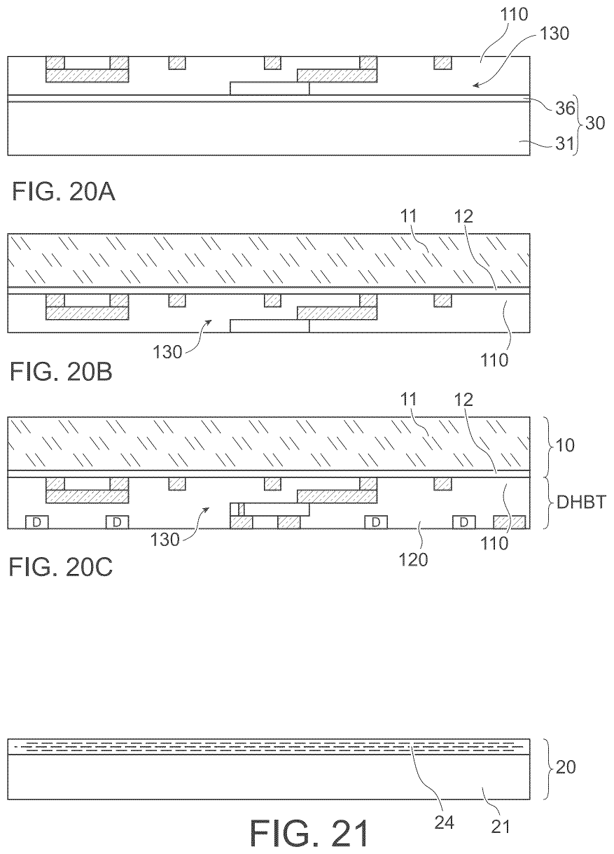

According to an embodiment, DHBT transistors are manufactured from an advanced 200-mm diameter substrate consisting of solid sapphire 30 paved with 1×1 mm² InP patches having a 0.5-μm thickness. Since InP substrates are not available with a 200-mm diameter, and to decrease the consumption of material, these patches can be obtained according to known so-called ‘rebuilt wafer’ (with Si substrates containing unprocessed InP dies) and film transfer (application of Smart Cut™ to the rebuilt wafer) technologies. The InP patches are spaced apart by 5.5 mm so as to be able to subsequently integrate CMOS functions without blocking the RF signals emitted by the DHBT. Sapphire substrate 30 comprises a solid sapphire substrate 31 covered with sacrificial nitride layers 36 compatible with a removal of the substrate according to the laser lift-off (LLO) technique. A first damascene interconnection level 110 is created to connect the InP transistors, after which a second level of routing and DHBT1 connection is formed, having its design adapted to being connected to the last metal level of the CMOS (FIG. 20A). The connection pitch is in the order of 1 μm. The DHBT function is transferred to a 200-mm sapphire donor 10 (comprising a solid sapphire substrate 11 covered by a nitride layer 12) by direct oxide-oxide bonding and removal of the initial sapphire substrate 30 by LLO (exposure of the back side of sapphire 31 to a laser beam which degrades nitride layers 36). The direct oxide-oxide bonding includes the insertion of nitride layers on the sapphire donor (FIG. 20B). TSVs are then formed through the bonding oxide layers used for Smart Cut™ and through the InP and an interconnection layer 120 formed of a damascene routing and connection level DHBT2 is then formed on the TSVs, the design of which is adapted to being connected to the digital function (FIG. 20C). A functional block labeled ‘DHBT’ is thus obtained. The connection pitch is in the order of 5 μm.

In parallel, a digital circuit 24 is formed on a 200-mm high-resistivity Si substrate 21 in order to limit RF losses in the final substrate 20 (FIG. 21). The last metal layer of the digital circuit is adapted to being connected to the DHBT function.

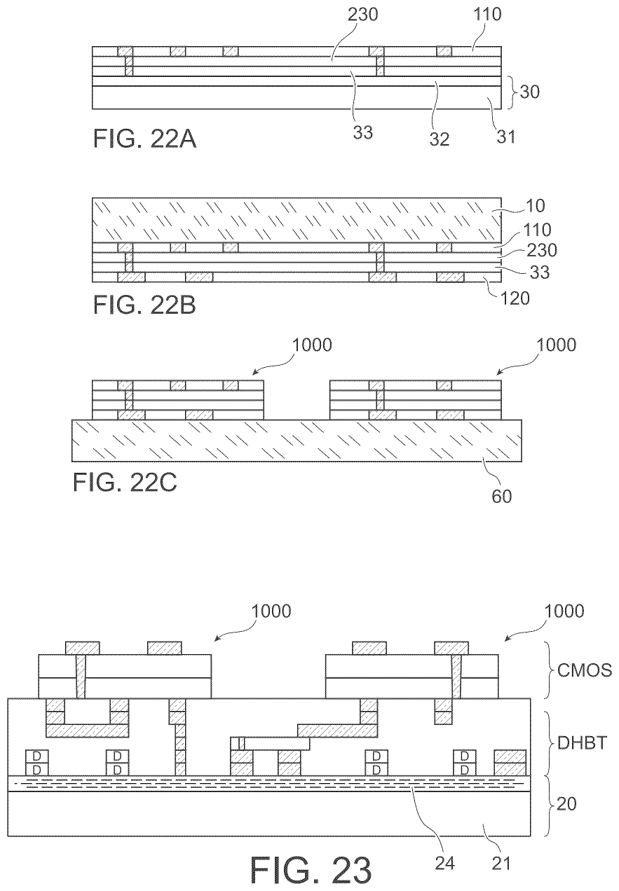

In parallel, CMOS circuits are formed on a 200-mm SOI 30 substrate to form a functional layer 230. The Si layer 33 located above buried oxide 32 has a 10-μm thickness, and the CMOS components have a thickness in the order of from 1 to 2 μm. A first interconnection layer 110 comprising a damascene routing and connection level CMOS1 is connected to the CMOS circuits. Its design is adapted to being connected to the DHBT function (FIG. 22A). TSVs are formed from the FEOL of the CMOSs to the BOX. The CMOS function is then transferred to a silicon donor substrate 10 by bonding and removal of the Si 31 located under BOX 32 (FIG. 22B) and a second interconnection layer 120 formed of a damascene routing and CMOS connection level is then formed on the TSVs, the design of which is adapted for the final packaging connections. The assembly is placed on an adhesive substrate 60 (‘tape’), thinned down to the BOX and cut into dies 1000 of 2×5 mm² (FIG. 22C).

One thus obtains:
a DHBT functional block on a 200-mm sapphire donor substrate 10 ready for assembly,
a CMOS functional block on a 200-mm Si donor substrate 10 ready for assembly,
a 200-mm Si digital RF receiver substrate 20 ready for assembly.

The DHBT block is transferred to the Digital block at the wafer scale by SAB-assisted aligned hybrid bonding and removal of the sapphire by LLO. The SAB bonding is performed at room temperature. The implementation of an SAB bonding enables to do away with the need for a bonding consolidation anneal due to the efficiency of the surface activation. The transfer of the InP DHBT dies from a sapphire substrate to a Si substrate can thus be entirely carried out at room temperature. This process thus enables to eliminate thermo-mechanical stress during and after assembly, and thus to avoid problems of cracking, and even delamination, that can be observed in the case of a direct transfer of InP to silicon.

The cut and thinned CMOS blocks are then transferred to the DHBT block by die-to-wafer aligned hybrid bonding. The CMOS dies on tape are assembled on the DHBT/digital stack by using so-called pick-and-place equipment compatible with direct bonding (that is, without particles, including a surface cleaning, etc.) and die alignment at a 1-μm pitch.

A CMOS/DHBT/digital stack on a high-resistivity Si substrate is thus obtained (FIG. 23).

The conventional RF packaging steps are then applied: dispensing of BCB resins, forming of a redistribution layer in the BCB layers, cutting into 5.5×5.5-mm² dies for packaging.

Various embodiments and variants have been described. Those skilled in the art will understand that certain features of these various embodiments and variants may be combined, and other variants will occur to those skilled in the art.

Finally, the practical implementation of the described embodiments and variants is within the abilities of those skilled in the art based on the functional indications given hereabove.

1. Manufacturing process for a 3D assembly comprising the following steps:
providing at least two assemblies, each comprising a donor substrate covered by a functional block successively comprising a first interconnection layer, a functional layer, and a second interconnection layer, the functional layer comprising one or more electronic components, the first interconnection layer and the second interconnection layer comprising a dielectric material in which are formed conductive elements, preferably made of copper, a first surface of the first interconnection layer in contact with the donor substrate and the free surface of the second interconnection layer being planarized so as to be compatible with a subsequent direct bonding,
successively transferring, to a receiver substrate, the functional blocks, by direct bonding, the conductive elements of the first interconnection layer of the first functional block being opposite and in contact with the conductive elements of the second interconnection layer of the second functional block, whereby a 3D assembly comprising a receiver substrate covered by a stack of two functional blocks is obtained.

2. Method according to claim 1, wherein at least 5 functional blocks, preferably at least 10 functional blocks, are transferred successively onto the receiver substrate.

3. Method according to claim 1, wherein after the transfer of the functional blocks, the method comprises the following steps:
bonding the 3D assembly to an adhesive,
cutting the receiver substrate and the functional blocks and removing the receiver substrate, whereby a plurality of stacks of singulated functional blocks are obtained,
optionally, bonding the different stacks of singulated functional blocks onto an external element, such as a printed circuit board or a laminated substrate.

4. Method according to claim 1, wherein one of the functional blocks partially covers the donor substrate, interconnection blocks being arranged, on the donor substrate, on each side of said functional block and wherein said functional block and the interconnection blocks are transferred simultaneously onto the receiver substrate.

5. Method according to claim 1, wherein at least one of the assemblies is obtained according to the following steps:
providing a temporary substrate covered by the functional layer,
forming the first interconnection layer on a first surface of the functional layer and planarizing it,
transferring the first interconnection layer and the functional layer onto the donor substrate, by bonding the donor substrate to the functional layer and separating the temporary substrate,
forming the second interconnection layer on a second surface of the functional layer,
planarizing the second interconnection layer.

6. Process according to claim 1, wherein part of or all the functional blocks comprise electronic dies.

7. Process according to claim 1, wherein the receiver substrate is covered by an interconnection layer comprising a dielectric material in which are formed conductive elements.

8. Process according to claim 1, wherein the functional layer has a thickness smaller than 100 μm and, preferably, smaller than 50 μm.

9. Process according to claim 1, wherein the bonding energy between the donor substrate and the functional block is smaller than the bonding energy between the functional block and the receiver substrate, or the donor substrate comprises a buried fragile layer.

10. Process according to claim 1, wherein the donor substrate is covered by a stack of a plurality of functional blocks, and wherein, during the transfer step, the stack of functional blocks is transferred in a single operation onto the receiver substrate.

11. Method of determining the steps of a 3D assembly manufacturing process, the determination method comprising the following steps:
defining functions of the 3D assembly, the 3D assembly comprising a substrate and a stack of different functional blocks,
each functional block comprising a functional layer, comprising one or more electronic components, arranged between two interconnection layers, the interconnection layers comprising a dielectric material in which are formed conductive elements, preferably made of copper,
each functional block being planar,
simulating the 3D assembly by selecting different natures and/or dimensions of the substrate and/or of the functional blocks and/or by selecting different stacks of functional blocks,
whereby a first manufacturing process for the 3D assembly is selected.

12. Method according to claim 11, wherein at least another manufacturing process for the 3D assembly is defined and compared with the first 3D assembly manufacturing process, according to several criteria, for example in terms of feasibility, technical risk, functionality, cost, and/or impact on the environment, so as to select the most suitable 3D assembly manufacturing process.

13. 3D assembly comprising a receiver substrate on which are stacked at least two functional blocks, preferably at least 5 functional blocks, even more preferably at least 10 functional blocks,
each functional block comprising a functional layer comprising one or more electronic components, arranged between two interconnection layers, the interconnection layers comprising a dielectric material in which are formed conductive elements, preferably made of copper,
each functional block being planar.

14. Assembly according to claim 13, wherein each functional block comprises an electronic die.

15. Assembly comprising a donor substrate covered by a functional block successively comprising a first interconnection layer, a functional layer, and a second interconnection layer, the functional layer comprising one or more electronic components, the first interconnection layer and the second interconnection layer comprising a dielectric material in which are formed conductive elements, preferably made of copper, a first surface of the first interconnection layer in contact with the donor substrate and the free surface of the second interconnection layer being planarized so as to be compatible with a subsequent direct bonding.
